(19) United States
(12) Patent Application Publication
(10) Pub. No.: US 2004/0156551 A1
(43) Pub. Date: Aug. 12, 2004

(54) Image compression method and image compression apparatus

(75) Inventor: Akio Nishiyama, Saitama (JP)

Correspondence Address: MCGINN & GIBB, PLLC, 8321 OLD COURTHOUSE ROAD, SUITE 200, VIENNA, VA, 22182-3817, US

(73) Assignee: Fuji Photo Film Co., Ltd., Minami Ashigara-shi (JP)

(21) Appl. No.: 10/698,368

(22) Filed: Nov. 3, 2003

(30) Foreign Application Priority Data
Nov. 7, 2002 (JP) P2002-323923

(51) Int. Cl. G06K 9/36; G06K 9/38

(52) U.S. Cl. 382/239; 382/251

(57) ABSTRACT

An image compression apparatus includes an input section, a compression process section, a compression characteristics storing section, and an output section and performs a compression process on image data inputted through the input section to output compressed image data. Compression characteristics data indicating a relationship between a bit rate which is the ratio between the data volume and the number of pixels of image data and a compression parameter are stored in the compression characteristics storing section. The compression process section acquires an initial compression parameter based on compression characteristics data of an average image and a target bit rate and performs an initial compression process. When there is great difference between a bit rate resulting from the compression process and the target bit rate, a corrective compression parameter is acquired to perform a compression process.

### BACKGROUND OF THE INVENTION

1. Field of the Invention

The present invention relates to an image compression method and an image compression apparatus for compressing image data.

2. Description of the Related Art

JPEG compression is known as a technique for compressing and coding image data. According to JPEG compression, redundancy is reduced utilizing a high level of correlation between items of image data. The volume of data whose redundancy has been reduced (compression rate) can be changed by changing a compression parameter which is referred to as a “Q-value” (Q factor). The Q-value is an image quality factor. An image has lower quality and a higher compression rate, the smaller the Q-value. However, a constant Q-value does not necessarily result in a constant compression rate, and the relationship between the Q-value and the compression rate depends on the characteristics (resolution, complexity, and so on) of images to be compressed.

In some applications such as a process of generating image data for a portable telephone, the volume of data after compression must be kept within a limit when image data is compressed. However, the data volume of image data thus generated must be kept in a predetermined range even in such a case because image quality is reduced when the data volume is too small.

In order to keep the data volume of generated image data within a predetermined range, a compression process has been performed according to the following procedure according to the related art. FIG. 5 shows a schematic flow of the process.

First, a Q-value used for the compression process is set (step 501). The set value is a constant value that is determined in advance. At step 502, a compression process is performed on image data of an image of interest using the Q-value, and the data volume of image data thus generated is acquired (step 503). It is judged at step 504 whether the data volume of the generated data upwardly exceeds a predetermined range of limitation and, if yes, the Q-value used for the compression process is decreased (step 505). Then, the processes at step 502 and later are repeated.

When the data volume of the generated image data does not upwardly exceed the predetermined range of limitation, it is judged at step 506 whether the data volume of the generated image data downwardly exceeds the predetermined rage of limitation and, if yes, the Q-value used for the compression process is increased (step 507). Then, the processes at step 502 and later are repeated. When it is judged at step 506 that the range of limitation is not downwardly exceeded, the process is terminated because it means that the data volume of the generated image data is within the range of limitation.

When a compression process is performed according to such a procedure, it is not easy to set an initial Q value at step 501 appropriately and to set the values of the decrease in the Q-value at step 505 and the increase in the Q-value at step 507 appropriately. The compression process is performed many times until an optimum Q-value is reached, which results in the problem of a low processing speed.

JP-A-11-18089 discloses a method for finding a Q-value for acquiring image data having a predetermined data volume based on a data volume acquired through a pre-compression process on image data in a sampling area set in a certain position on a screen. According to this method, a Q-value is found by performing a predetermined operational expression based on a data volume at the time of a pre-compression process and a target data volume.

However, this method essentially involves a pre-compression process in a sampling area and inevitably results in an increase in processing time that is required for performing the pre-compression process. When there is a great difference between a data volume acquired as a result of compression using a Q-value obtained by the predetermined operational expression and a target data volume, it is not easy to find an optimum Q-value, which results in a further increase in processing time.

JP-A-11-18089 is known as a related art.

### SUMMARY OF THE INVENTION

The object of the invention is to provide an image compression method and an image compression apparatus in which the data volume of compressed image data can be kept within a range of limitation.

The invention provides an image compression method for compressing image data according to the invention includes a compression characteristics storing step for storing compression characteristics data indicating compression characteristics of plural types of images in advance, a first compression parameter acquisition step for acquiring an initial compression parameter, a second compression parameter acquisition step for acquiring a corrective compression parameter, and a compression process step for performing a compression process on image data of an image to be compressed based on the initial compression parameter or the corrective compression parameter. The compression characteristics indicate a relationship between a bit rate, which is a ratio between data volume and the number of pixels of image data, and a compression parameter associated with image quality and compression rate of the compression process. The first compression parameter acquisition step acquires the initial compression parameter based on compression characteristics data of an average image and a target bit rate. The second compression parameter acquisition step includes the step of acquiring information indicating complexity of the image to be compressed based on the bit rate of compressed image data acquired at the compression process step, compression parameters used at the compression process step, and the compression characteristics data, and the step of acquiring the corrective compression parameter based on compression characteristics data on an image having the complexity and the target bit rate.

Furthermore, the compression process is a compression process based on JPEG standard, and the compression parameter is a Q-value.

The invention provides an image compression apparatus for compressing image data according to the invention has a compression characteristics storing section for storing compression characteristics data indicating compression characteristics of plural types of images, and a compression process section for performing a compression process on image data of an image to be compressed. The compression characteristics indicate a relationship between a bit rate, which is a ratio between data volume and the number of pixels of image data, and a compression parameter associated with image quality and compression rate of the compression process. The compression process section includes a compression parameter acquisition unit for acquiring an initial compression parameter and a corrective compression parameter, and a compression process performing unit for performing the compression process based on the initial compression parameter or the corrective compression parameter. The compression parameter acquisition unit acquires the initial compression parameter based on the compression characteristics data on an average image and a target bit rate and acquires the corrective compression parameter based on information indicating complexity of the image to be compressed, the compression characteristics data of an image having the complexity, and the target bit rate. The compression process section estimates the complexity of the image to be compressed based on the bit rate of compressed image data acquired by the compression process, compression parameters used at the compression process, and the compression characteristics data.

Furthermore, the compression process is a compression process based on JPEG standard, and the compression parameter is a Q-value.

### BRIEF DESCRIPTION OF THE DRAWINGS

FIG. 1 shows a schematic configuration of an embodiment of an image compression apparatus according to the invention;

FIG. 2 shows an example of compression characteristics data;

FIG. 3 shows a schematic flow of a compression process according to the invention;

FIG. 4 illustrates a method of selecting a Q-value for a compression process; and

FIG. 5 shows a schematic flow of a compression process according to the related art.

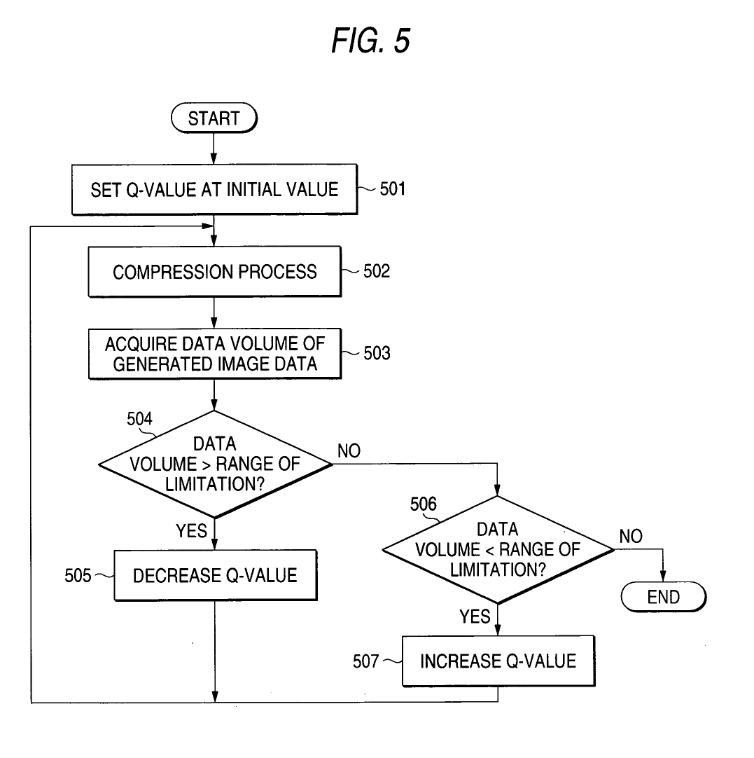

### DETAILED DESCRIPTION OF THE PREFERRED EMBODIMENTS

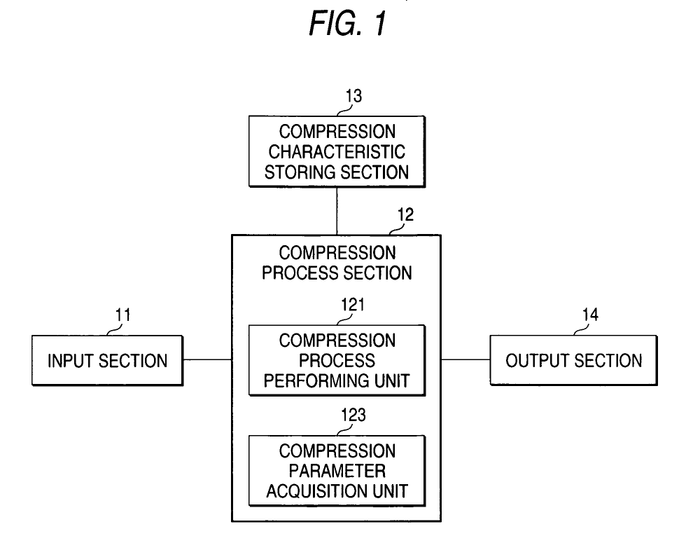

An embodiment of the invention will now be described with reference to the drawings. FIG. 1 shows a schematic configuration of an embodiment of an image compression apparatus according to the invention. An image compression apparatus of FIG. 1 includes an input section 11, a compression process section 12, a compression characteristics storing section 13, and an output section 14. The image compression apparatus performs a compression process on image data inputted through the input section 11 to output compressed image data. The compression process is a compression process according to the JPEG standard.

The compression process apparatus of FIG. 1 primarily has a processor (not shown) which operates based on a predetermined program. The processor may constitute a standalone computer. Alternatively it may be incorporated in an apparatus such as a digital camera or used also as a processor to enable other functions of the apparatus.

The input section 11 is for inputting image data to be compressed and various data used for a compression process such as a target data volume to be achieved by compression. For example, the input section 11 is an input device of a standalone computer. Alternatively, when incorporated in the apparatus, it may be a memory for exchanging data with other functional blocks.

The compression process section 12 has a compression process performing unit 121 and a compression parameter acquisition unit 123. The compression process performing unit 121 executes calculations for a known JPEG compression process (a discrete cosine transform process, a quantization process, a Huffman cording process, or the like) on the basis of a selected Q-value according to a predetermined program. The compression parameter acquisition unit 123 acquires a Q-value. The compression parameter acquisition unit 123 refers to data in the compression characteristics storing section 13 depending on the target data volume and the complexity of the image to be compressed to acquire the Q-value. Details of the selection of the Q-value will be described later.

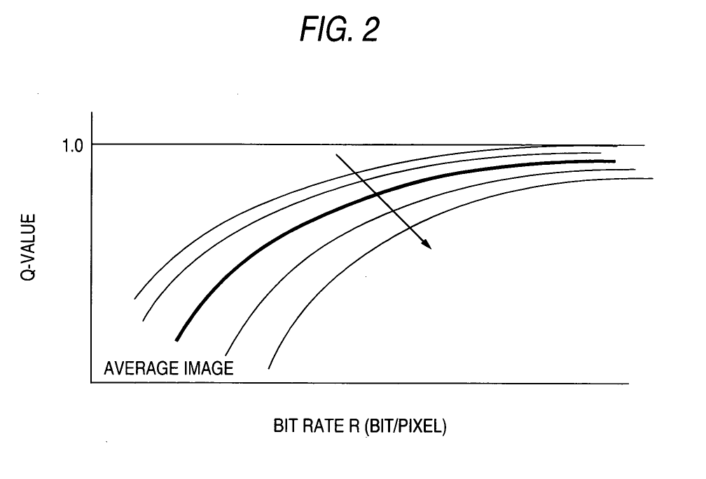

The compression characteristics storing section 13 is for storing compression characteristics data indicating compression characteristics of plural types of images in advance. The compression characteristics of an image to be stored indicate a relationship between a Q-value that is a compression parameter associated with the image quality and compression rate of a compression process and a bit rate that is a ratio between the data volume and the number of pixels of the image data. FIG. 2 shows an example of compression characteristics data. As shown in FIG. 2, when the image quality of a compressed image is improved by increasing the Q-value (which is variable between 0 and 1), the data volume and the bit rate of compressed image data thus acquired are increased. When the image to be compressed becomes more complex, it will have a relatively greater bit rate, and its characteristic curve will be shifted in the direction indicated by the arrow in FIG. 2.

The compression characteristics are determined in advance according to the following procedure. First, a compression process is performed on original image data using a predetermined Q-value, and a bit rate is acquired from the data volume of resultant image data and the number of pixels of the original image. Such a compression process is performed plural times with the Q-value varied to perform similar compression processes on a greater number of sample images. Compression characteristics of an average image and compression characteristics of a plurality of images that are different in complexity are acquired in advance from the characteristics of the sample images. While FIG. 2 shows the characteristics of four types of images that are different in complexity as well as the characteristics of an average image, there may be any number of images of different types. Characteristics as shown in FIG. 2 are stored in the compression characteristics storing section 13 as compression characteristics data. The characteristics may be stored in the form of a table or in the form of functions that approximate them.

The output section 14 outputs image data that have been subjected to a compression process. For example, the output section 14 is an output device of a standalone computer and, when it is incorporated in the apparatus, it may alternatively be a memory for exchanging data with other functional blocks.

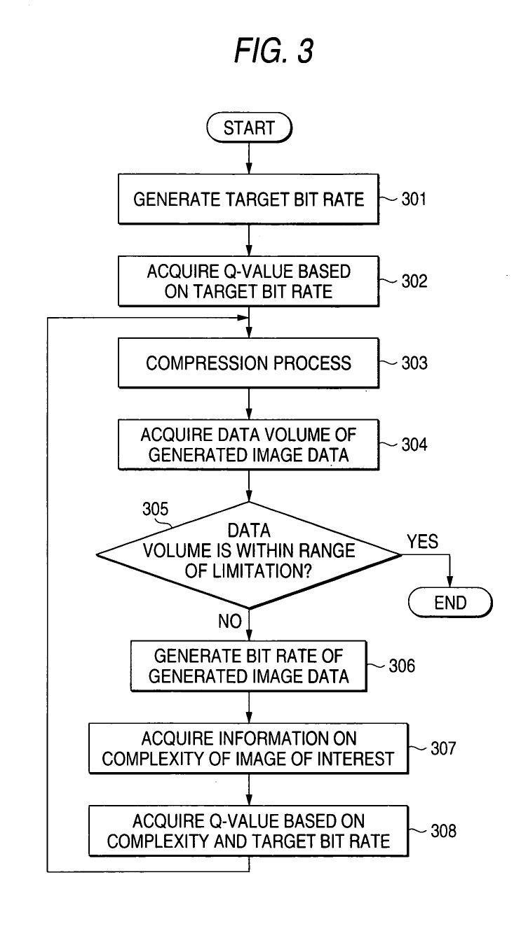

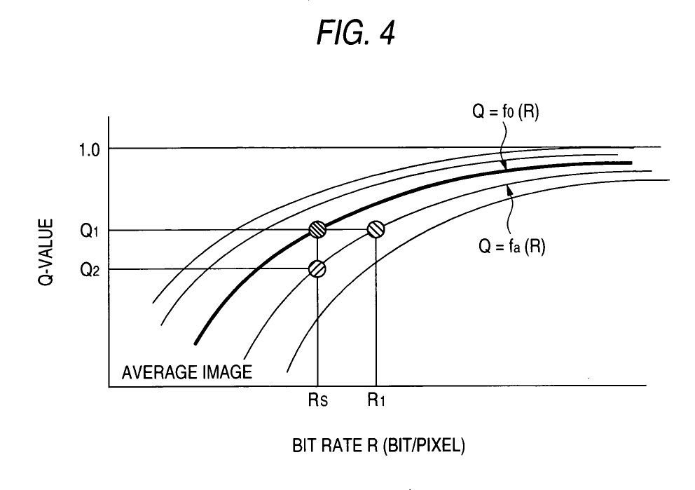

A description will now be made on the compression process on image data performed by the compression process section 12 with reference to the schematic flow chart of the compression process shown in FIG. 3 and the method of selecting a Q-value for the compression process shown in FIG. 4. At step 301, a target bit rate Rs=(target data volume)/(number of pixels) is acquired from the number of pixels of original image data to be compressed and a target data volume of compressed image data. At step 302, an initial Q-value Q₁ is acquired based on the target bit rate Rs and the compression characteristics data in the compression characteristics storing section 13. The initial Q-value Q₁ is acquired based on the compression characteristics data of the average image and the target bit rate Rs. That is, Q₁=f₀(Rs) where the compression characteristics of the average image are represented by Q=f₀(R) (R represents the bit rate).

A compression process is then performed using Q₁ as the Q-value (step 303), and the data volume of image data generated by the compression process is acquired (step 304). At step 305, it is judged whether the acquired data volume is within a range of limitation and, when it is within the range of limitation, the compression process is terminated. The judgment on whether the acquired data volume is within the range of limitation is made by judging whether an error of the acquired data volume from the target data volume is within a predetermined value. When the target data volume is set as an upper limit, the compression process is terminated only when the acquired data volume is smaller than the target data volume. When it is only required to perform compression to a volume equal to or smaller than the target data volume, the compression process terminates if the acquired data volume is equal to or smaller than the target data volume.

When the image to be processed is an image having an average level of complexity, there is a high probability that the image is judged to be within the range of limitation at step 305, and compressed image data having the target data volume will be acquired by one compression process. However, an image is not always on the average, and even an average image does not necessarily come out with a target data volume. When the result of the judgment at step 305 is out of the range of limitation, the bit rate R₁ of the generated image data is acquired (step 306) to acquire information indicating the complexity of the image to be processed (step 307). Assuming that the bit rate R₁ of the generated image data is a value as shown in FIG. 4, a function that gives the bit rate R₁ when the Q-value is Q₁ (Q=fa(R) in the example in FIG. 4) is acquired with reference to the compression characteristics data in the compression characteristics storing section 13, and information that identifies the function is regarded as information indicating the complexity of the image. The function that gives the bit rate R₁ when the Q-value is Q₁ may not be stored depending on the number of functions that are stored. In such a case, information that identifies two functions substantially approximating the value is regarded as the information indicating the complexity of the image. When the ratio between the distances to the respective functions is included in the information indicating complexity, the accuracy of an interpolation process to be described later (see step 308) will be improved.

When information indicating the complexity of the image of interest is acquired, the Q-value is acquired again at step 308 based on the associated function and the target bit rate Rs. In the example in FIG. 4, R=Rs is substituted in the function Q=fa(R) to the Q₂=fa(Rs). When two functions have been identified, data acquired from each of the functions are interpolated to the Q₂. When the ratio between the distances to the respective functions has been acquired, interpolation is performed using the ratio. When the ratio has not been acquired, an intermediate value is used. The process then returns to step 303 at which a compression process is performed using Q₂ that is the newly acquired Q-value, and the same process is repeated until the data volume of the image data thus generated comes in the range of limitation.

Since the newly acquired Q-value is a Q-value for which the complexity of the image to be processed is taken into consideration as thus described, the data of the generated image data agrees with the target data volume with a high probability, which allows the compression process to be performed at a high speed.

The example in FIG. 4 has been described on an assumption that the compression characteristics data are functions. When the data are in the form of a table, interpolation is performed between items of data stored in the table to acquire the Q-value.

As explained above, it is possible to provide an image compression method and an image compression apparatus that allow the data volume of compressed image data to be kept in a certain range of limitation.

What is claimed is:

1. An image compression method for compressing image data, comprising:
a compression characteristics storing step for storing compression characteristics data indicating compression characteristics of plural types of images in advance;
a first compression parameter acquisition step for acquiring an initial compression parameter;
a second compression parameter acquisition step for acquiring a corrective compression parameter; and
a compression process step for performing a compression process on image data of an image to be compressed based on the initial compression parameter or the corrective compression parameter, wherein
the compression characteristics indicate a relationship between a bit rate, which is a ratio between data volume and the number of pixels of image data, and a compression parameter associated with image quality and compression rate of the compression process;
the first compression parameter acquisition step acquires the initial compression parameter based on compression characteristics data of an average image and a target bit rate; and
the second compression parameter acquisition step includes the steps of:
acquiring information indicating complexity of the image to be compressed based on the bit rate of compressed image data acquired at the compression process step, compression parameter used at the compression process step, and the compression characteristics data; and
acquiring the corrective compression, parameter based on compression characteristics data of an image having the complexity and the target bit rate.

2. The image compression method according to claim 1, wherein the compression process is a compression process based on JPEG standard, and wherein the compression parameter is a Q-value.

3. An image compression apparatus for compressing image data, comprising:
a compression characteristics storing section for storing compression characteristics data indicating compression characteristics of plural types of images; and
a compression process section for performing a compression process on image data of an image to be compressed, wherein
the compression characteristics indicate a relationship between a bit rate, which is a ratio between data volume and the number of pixels of image data, and a compression parameter associated with image quality and compression rate of the compression process;
the compression process section includes a compression parameter acquisition unit for acquiring an initial compression parameter and a corrective compression parameter, and a compression process performing unit for performing the compression process based on the initial compression parameter or the corrective compression parameter;
the compression parameter acquisition unit acquires the initial compression parameter based on compression characteristics data of an average image and a target bit rate and acquires the corrective compression parameter based on information indicating complexity of the image to be compressed, the compression characteristics data of an image having the complexity, and the target bit rate; and
the compression process section estimates the complexity of the image to be compressed based on the bit rate of compressed image data acquired by the compression process, compression parameters used at the compression process, and the compression characteristics data.

4. The image compression apparatus according to claim 3, wherein the compression process is a compression process based on JPEG standard, and wherein the compression parameter is a Q-value.

5. An image compression apparatus for compressing image data, comprising:
a compression characteristics memory which stores compression characteristics data indicating compression characteristics of plural types of images; and
a compression processor which performs a compression process on image data of an image to be compressed, wherein
the compression characteristics indicate a relationship between a bit rate, which is a ratio between data volume and the number of pixels of image data, and a compression parameter associated with image quality and compression rate of the compression process;
the compression processor includes a compression parameter acquisition unit which acquires an initial compression parameter and a corrective compression parameter, and a compression process performing unit which performs the compression process based on the initial compression parameter or the corrective compression parameter;
the compression parameter acquisition unit acquires the initial compression parameter based on compression characteristics data of an average image and a target bit rate and acquires the corrective compression parameter based on information indicating complexity of the image to be compressed, the compression characteristics data of an image having the complexity, and the target bit rate; and
the compression processor estimates the complexity of the image to be compressed based on the bit rate of compressed image data acquired by the compression process, compression parameters used at the compression process, and the compression characteristics data.
